(19) United States
(12) Patent Application Publication
(10) Pub. No.: US 2006/0179342 A1
(43) Pub. Date: Aug. 10, 2006

(54) Service aggregation in cluster monitoring system with content-based event routing

(75) Inventors: Paul Reed, Brookline, MA (US); Christopher R. Vincent, Arlington, MA (US); Wing C. Yung, Somerville, MA (US)

Correspondence Address: FLEIT, KAIN, GIBBONS, GUTMAN,;BONGINI & BIANCO P.L., 551 NW 77TH STREET, SUITE 111, BOCA RATON, FL, 33487, US

(73) Assignee: INTERNATIONAL BUSINESS MACHINES CORPORATION, ARMONK, NY (US)

(21) Appl. No.: 11/052,695

(22) Filed: Feb. 7, 2005

(51) Int. Cl. G06F 11/00

(52) U.S. Cl. 714/4

(57) ABSTRACT

A node manager (300) resides on a node (104) in a cluster computing system (100) and transfers information and events being communicated across the node (104) to a broker (102) coupled to the node manager (300). The broker (102) transmits information to client devices (106) who subscribe to particular events. The client devices (106) publish their own messages back to the broker (102) or to a second broker (1002). Other client device (1102) can then subscribe to receive the messages from either broker (102 or 1002). The other client devices (1102) can then publish their own messages back to the brokers for subscription by further client devices (902).

### CROSS REFERENCE TO RELATED APPLICATION

The present patent application is related to co-pending and commonly owned U.S. patent application Ser. No. ______, Attorney Docket No. POU920040150US1, entitled “CLUSTER MONITORING SYSTEM WITH CONTENT-BASED EVENT ROUTING”, filed on the same day as the present patent application, the entire teachings of which being hereby incorporated by reference.

### FIELD OF THE INVENTION

The present invention relates, in general to content-based event monitoring, routing, and publishing in a cluster computing environment, and more particularly relates to the aggregation of services in the cluster computing environment.

### BACKGROUND OF THE INVENTION

Distributed systems are scalable systems that are utilized in various situations, including those situations that require a high-throughput of work or continuous or nearly continuous availability of the system.

A distributed system that has the capability of sharing resources is referred to as a cluster. A cluster includes operating system instances, which share resources and collaborate with each other to perform system tasks.

An event computing system is an integrated group of autonomous components within a cluster. The cluster infrastructure is an interworking of connections allowing the resources of the cluster to communicate and work with each other over varying pathways.

Client devices are able to connect to the system infrastructure and monitor the resources and application status of the system. However, the client devices usually do not have the capacity or need to monitor every event that occurs on the system. Therefore, a publish/subscribe system is used.

A publish/subscribe system is system that includes information producers, which publish events to the system, and information consumers (client devices), which subscribe to particular categories of events within the system. The system ensures the timely delivery of published events to all interested subscribers. In addition to supporting many-to-many communication, the primary requirement met by publish/subscribe systems is that producers and consumers of messages are anonymous to each other, so that the number of publishers and subscribers may dynamically change, and individual publishers and subscribers may evolve without disrupting the entire system.

Prior publish/subscribe systems were subject-based. In these systems, each message belongs to one of a fixed set of subjects (also known as groups, channels, or topics). Publishers are required to label each message with a subject; consumers subscribe to all the messages within a particular subject. For example a subject-based publish/subscribe system for stock trading may define a group for each stock issue; publishers may post information to the appropriate group, and subscribers may subscribe to information regarding any issue.

An emerging alternative to subject-based systems is content-based messaging systems. A significant restriction with subject-based publish/subscribe is that the selectivity of subscriptions is limited to the predefined subjects. Content-based systems support a number of information spaces, where subscribers may express a “query” against the content of messages published. For example, there might be a channel for all stock updates for “IBM.” In the content-based system, one would still subscribe to the subject-based IBM channel, but could specify a selector like “price >$100”. Only messages reporting the stock price at a level over $100 would be published.

Two examples of a content-based publish/subscribe system are the WebSphere Business Integration Message Broker (described at http://www-306.ibm.com/software/integration/wbimessagebroker/v5/multiplatforms.html) and the Gryphon System (described at http://www.research.ibm.com/gryphon), both by International Business Machines, Inc., New Orchard Road, Armonk, N.Y. 10504.

In a publish/subscribe system subscribers express interest in future information by some selection criterion, i.e., a client device will “subscribe” to particular events. For example, a client device may wish to be notified anytime a particular database is updated. Therefore, the client will subscribe to that “event,” which in this example, is each time an entry in the database is added to or altered. A component on the system searches for the occurrence of the event that the client device has subscribed to and delivers the information to the client device and all other interested subscribers.

However, often times a client device requires information that is beyond that available from the system. For instance, a client device may wish to know average CPU load over a longer period of time than that measured by the system itself.

Therefore a need exists to overcome the problems with the prior art as discussed above.

### SUMMARY OF THE INVENTION

Briefly, in accordance with the present invention, disclosed is a cluster monitoring system with content-based event routing. The cluster is a data communication infrastructure with a plurality of nodes. At least one node manager resides on at least one of the nodes and forwards information and events being communicated across the node to a broker communicatively coupled to the node manager.

The broker, or group of brokers, transmits information to client devices who subscribe to particular events occurring on the system. The broker routes only the information matching the parameters that are set within the client's subscription.

The subscribing clients then publish their own information back to the brokers, which then route the subscribing client-published information to any member of a second set of subscribing client devices.

In another embodiment of the present invention, the subscribing client devices publish their own information to a second broker or group of brokers. A second set of subscribing clients can receive information from the second broker(s) that match parameters posted by the second set of clients.

In yet another embodiment of the present invention, any member of the second set of client devices can publish its own information to a broker or group of brokers. The information can then be subscribed to and received by other devices, which may also publish their own information.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram illustrating a system according to an embodiment of the present invention.

FIG. 2 is a data diagram showing three client subscriptions according to an embodiment of the present invention.

FIG. 3 is a diagram showing a node manager according to an embodiment of the present invention.

FIG. 4 is a diagram showing the internal structure of a node manager according to an embodiment of the present invention.

FIG. 5 is a diagram showing various flow control points within the system of FIG. 1 according to an embodiment of the present invention.

FIG. 6 is a diagram showing various types of clients coupled to the system of FIG. 1 according to an embodiment of the present invention.

FIG. 7 is a diagram showing a user interface for tracking the node manager and kernel probe web services according to an embodiment of the present invention.

FIG. 8 is an operational flow diagram illustrating an exemplary operational sequence for the system of FIG. 1, according to embodiments of the present invention.

FIG. 9 is a diagram showing the system of FIG. 6 with a subscribing device publishing its own events through the network infrastructure and another device subscribing to the events, according to an embodiment of the present invention.

FIG. 10 is a diagram showing the system of FIG. 9 with a subscribing device publishing its own events to a second set of brokers and another device subscribing to the events, according to an embodiment of the present invention.

FIG. 11 is a diagram showing the system of FIG. 10 with a subscribing device publishing its own events to a second set of brokers, another device subscribing to the events, and the other device publishing its own events, which are subscribed to by a third device, according to an embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

The present invention, according to an embodiment, overcomes problems with the prior art by providing a cluster computing system with various flow control points for deciding which messages should enter the system during times when information being placed on the system exceeds the system's capacity.

In accordance with the principles of the present invention, a routing system is provided, which facilitates the forwarding of events to subscribing clients. Specifically, in the context of a content-based publish/subscribe system deployed over a wide-area network, the routing infrastructure presented herein uses subscription parameters and event distribution sets to route content-specific events to interested consumers. More particularly, a cluster computing system is provided with various flow control points for deciding which messages should enter the system during times when information being placed on the system exceeds the system's capacity. The content-specific event messages are then routed only to the subscribing clients.

The subscribing clients then publish their own information to any member of a second set of subscribing client devices.

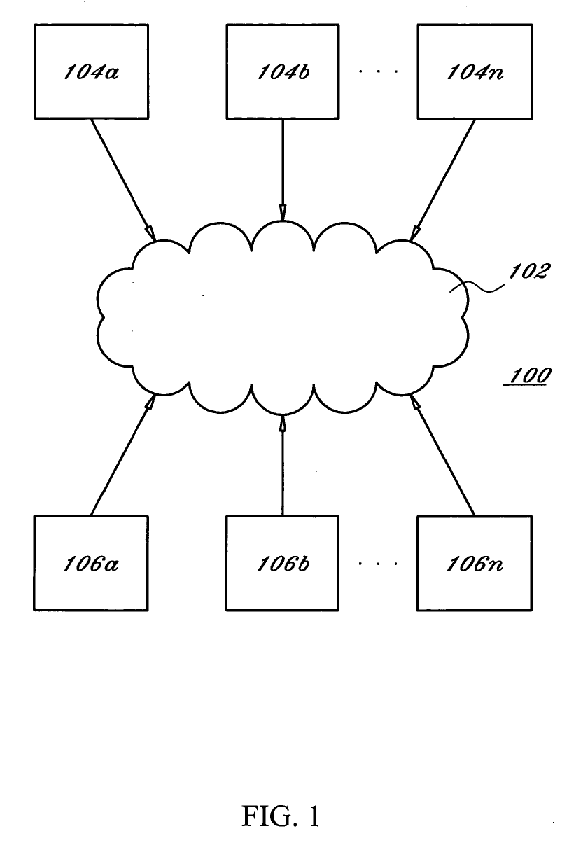

According to an embodiment of the present invention, a computing infrastructure 100 is shown in FIG. 1. In this infrastructure, an event broker 102 is connected to a plurality of nodes 104a-104n on a network, such as the Internet. Also shown in FIG. 1, the event broker 102 is assumed to have a number of clients 106a-106n, which are either applications running directly on the broker 102 or more usually, applications running on client devices attached to the broker 102. The broker 102, shown as a cloud, can be a single device or multiple broker devices.

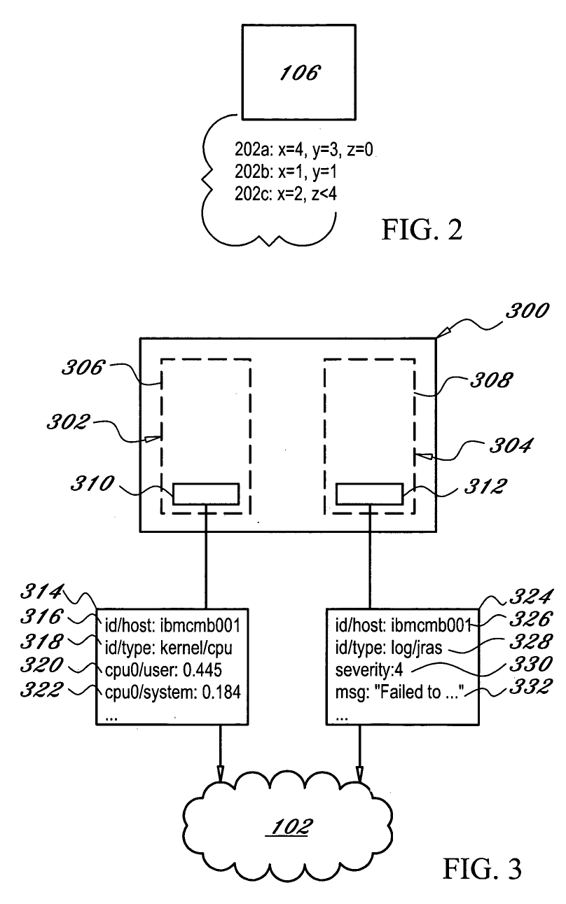

Each client 106a-106n can publish messages, whose content has been defined as parameters, such as x, y, and z, and values. Clients can also issue subscriptions, such as subscriptions 202a, 202b, and 202c, as depicted in FIG. 2, for clients such as client 106a, as shown in FIG. 1. Subscriptions are predicates on the parameters, such as y=3 and x<4. Subscriptions represent requests for the system to deliver event messages whose parameter values satisfy the predicate.

Brokers maintain tables which store the subscriptions of all the clients they serve. Brokers utilize the tables when an event is received to determine which clients should receive the event information.

The publish-subscribe feature as used in the exemplary embodiment of the present invention is more fully described in the commonly owned U.S. patent application Ser. No. 09/850,343, entitled “SCALABLE RESOURCE DISCOVERY AND RECONFIGURATION FOR DISTRIBUTED COMPUTER NETWORKS,” filed on May 7, 2001, the entire contents of which being hereby incorporated by reference herein.

Referring now to FIG. 3, a node manager 300 is shown. The node manager 300 resides on a node, such as nodes 104a-104n shown in FIG. 1. Each system 100 has at least one node manager 300 that resides on a single node and manages that node only. The node manager 300, according to its configuration information, provides a framework for a “probe” module 302 and an “adapter” module 304 on the single node. Each node can have at least one of an adapter 304 and/or a probe 302. In other words, each node can have only an adapter 304, or only a probe 302.

Probes are processes that run on the node, publishing messages on their own, according to a configurable schedule. An example of a probe 302 is a kernel performance monitoring probe, which periodically publishes information such as CPU or memory usage. Probes can be configured to publish events less frequently when the system is overloaded.

Also within the node manager 300 is an adapter module (also referred to as an agent module) 304, which intercepts existing events (such as an application log entry being written) and publishes them into the system 100. In other words, the agent performs a filtering function. The agent module 304 of the exemplary embodiment contains the program instructions for performing the action associated with that agent. Adapters can be configured to only publish certain types/severities of messages, limiting or disabling their output when the system is overloaded.

The adapter module 304 and probe module 302 according to various embodiments include either source code or program data in another format to define the processing performed by the particular module. The probe module 302 and agent module 304 are designed to execute in a particular runtime environment. A runtime specification of the exemplary module 300 specifies the runtime environment in which the particular module is to execute. Examples of runtime specifications include a Javascript runtime environment, a Perl runtime environment, Java Virtual Machine (JVM), an operating system, or any other runtime environment required by the particular module. An exemplary embodiment utilizes web services based upon the Simplified Object Access Protocol (SOAP) and Java Remote Method Invocation (RMI) to perform the processing performed by the probe module and agent module. Alternative embodiments use other protocols and communications means to implement the tasks of installing, querying, and managing the installed modules.

Probes 302 and adapters 304 may run within the same execution container, e.g., JVM, or in different containers 306 & 308, as shown in FIG. 3, on the same node, such as node 104a. Each execution container 306 & 308 maintains at least one connection to the publish/subscribe infrastructure 100. Additionally, each module 302 and 304 includes a publisher 310 and 312, respectively. The probe publisher 310 publishes system information, such as CPU or memory usage. An example of a probe publication 314 is given in FIG. 3. The publication identifies the host 316, the type of message 318, the user 320, and a system identifier 322, as well as other information. The probe publication is then sent and interpreted by a broker 102.

Also shown in FIG. 3, is an exemplary adapter publication 324. As stated above, the adapter 304 intercepts existing events and publishes them to a monitoring system, i.e., the broker 102. As can be seen in the exemplary adapter publication 324, a few of the fields communicated are host id 326, message type id 328, message severity 330, which is a weighted value assigned to the message, and the message itself 332. The adapters 304 can be configured to only publish certain types or severities of messages, limiting or disabling their output when the system is overloaded.

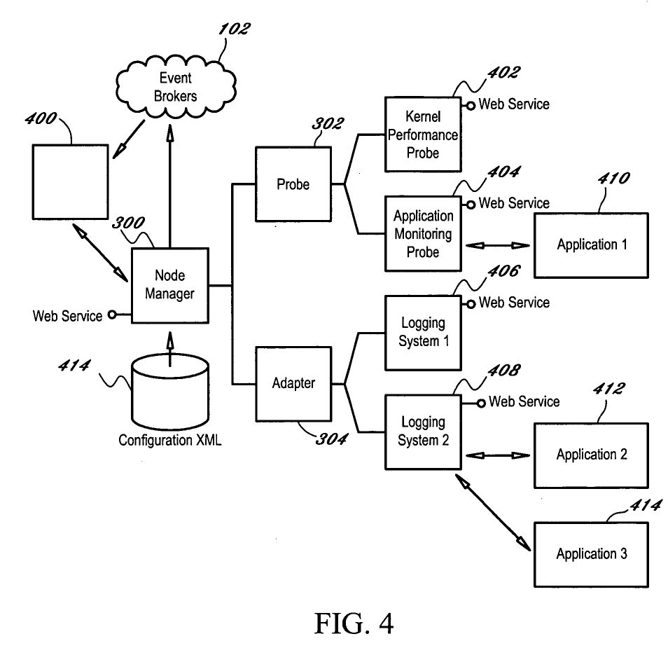

Referring now to FIG. 4, the internal structure of the node manager (within one execution container) installed on each monitored cluster node is shown in an exploded view. It should be noted that the node manager 300 may be implemented with any combination of software and/or hardware. The node manager 300 has a probe 302 and an adapter 304. The probe 302 includes a kernel performance probe 402 and an application monitoring probe 404. The application monitoring probe 404 is shown monitoring an application 410.

Looking now to the adapter 304, a first and second logging system 406 and 408, respectively, are connected. Java application servers, e.g., typically support a number of “logging frameworks” (standard APIs), which can be connected to and events can be harvested from. The logging systems 406 and 408 track and record the system events detected by the adapter 304. In FIG. 4, two applications 412 and 414 are tracked by the second logging system 408. Of course, the number of applications that can be tracked can be other than two.

All probes 302 and adapters 304 within a node manager 300 share a connection to the publish/subscribe infrastructure 100, and are configured from a shared configuration resource 414.

Also shown in FIG. 4 is an autonomic agent 400. The autonomic agent 400 is coupled to the broker 102 and the node manager 300. The autonomic agent 400 continuously monitors the broker 102 and determines what amount of information, if any, is being lost due to a traffic volume that is too high for the broker to properly handle. The agent 400 has a policy for reducing traffic on the system. If the agent 400 determines that the information flow is too heavy, it reduces the output of the node manager 300.

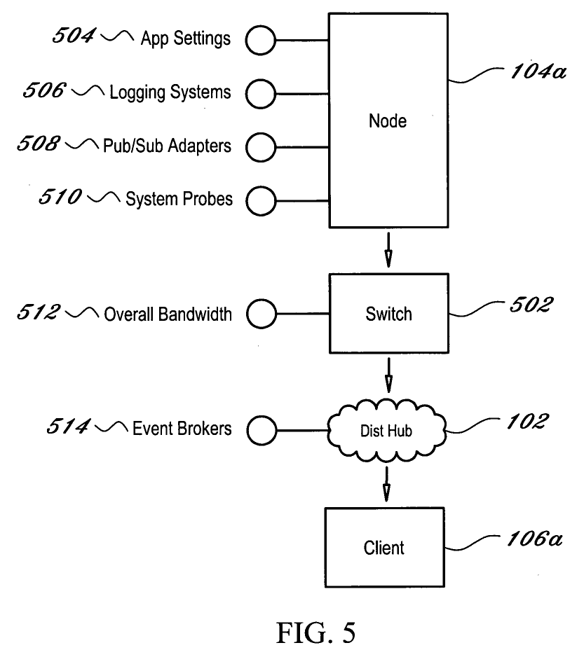

According to one exemplary embodiment, as illustrated FIG. 5, various flow control points can be utilized to manage the overall event rates. When the agent 400 determines that maximum capacity has been reached, the upstream control points are adjusted by the policy-driven autonomic agent 400 to reduce event output. The control points may also be adjusted “manually” by an operator.

Shown in FIG. 5 as the most “upstream” device is a node 104 with four control points. The control points are exposed web services. The first control point 504, in this example, is for the application settings. These generally relate to how much information an application places on the system 100 or writes to a logging framework. The second control point 506, in this example, is for the logging systems. The logging system can be adjusted so that it will discard some information according to level of importance, which is determined by values previously assigned to each piece of information.

The third control point 508 in the current example is for the adapters 304 within the node manager 300. The adapters 304, similar to the probes 302, can be configured to publish fewer messages onto the system. The final control point 510 on the node 104, in this example, is the system probes 302. The probes 302 can be configured to publish at a lower frequency during times of information traffic overflow. There are no requirements for prioritization as to which messages are limited by the adapters 304 and probes 302. However, the types of messages are given weight and priority. This type of flow control is advantageous in environments where the monitoring requirements cannot be determined in advance.

The next device in the “stream” of priority is a switch 502, which has a control point 512, for modifying the overall bandwidth of the system 100. In times of information overflow, the control point 512 of the switch 502 can be adjusted to increase or decrease the overall bandwidth of the system 100.

The final control point 514 of the system 100, according to the present example, is for event broker settings within the broker cloud 102. The broker cloud 102 can limit the output of the system 100 by reducing an amount of information being sent to the client devices 106.

In this way, the routing system of the present invention deals with traffic overflow gracefully. While prior-art publish/subscribe systems may crash or become unstable when too many messages are sent into the system, the publish/subscribe system of the present invention will discard messages and continue to function. Importantly, the system will continue to run even if the autonomous agent 400 does not adjust the flow control points. The autonomous agent 400 in not a necessary part of the implementation of the present invention—it is merely an example of a simple agent that may be useful.

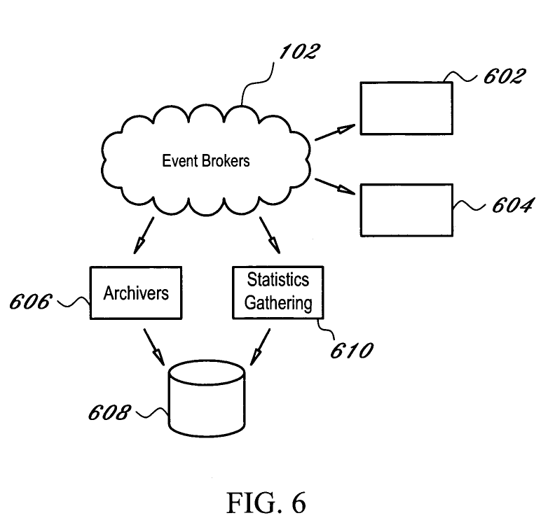

Referring now to FIG. 6, various types of clients may subscribe to events. For instance, a first client 602 may track CPU usage, while a second client 604 may track activity within a database. In addition, some clients provide new services themselves. As an example, the client device 606 is an archiving device that tracks the occurrence or non-occurrence of a certain event or events and then records the event activity in a memory 608 or other storage device. Another client device 610 is a statistics gathering device which interprets system activity and events and writes the data to the memory 608.

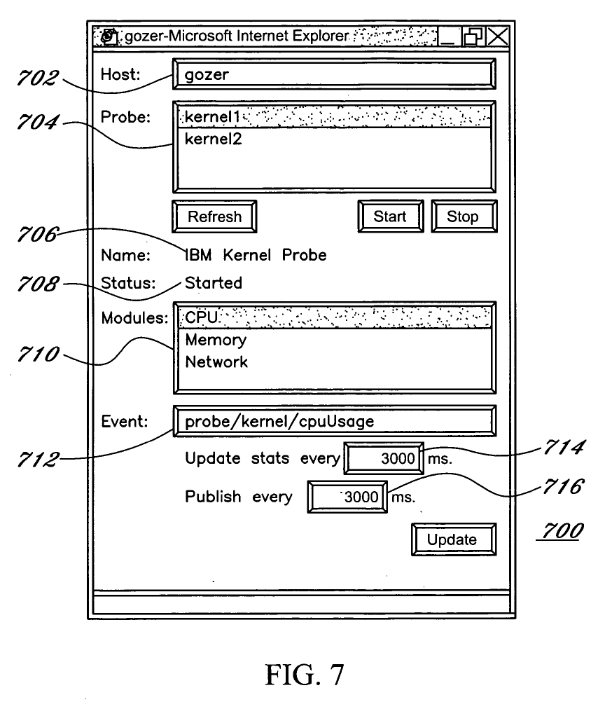

FIG. 7 shows a user interface 700 for configuring the node manager web service (start/stop) and a kernel probe web service (event name and update/publish frequency). The user interface 700 includes eight fields in the example shown, but can include more or less in practice.

Field 702 shows the particular host, or node 104, name. The second field 704 shows the available probes 302 on the particular node 104. In the figure, the probe being viewed is named “kernel 1” and the list with an unhighlighted item indicates that one alternative probe, kernel 2, is available. The third field 706 shows the name assigned to the selected probe, and the fourth field 708 indicates its status. In the example, the node status is “started”, meaning the kernel probe is actively monitoring the system 100. A second alternative status is “off”. Other statuses can be used to indicate various states of the probe.

Field 710 shows the list of modules that can be viewed. In the example, three modules are available: CPU, memory, and network. CPU is selected in the example and could be one of several aspects of CPU usage or non-usage. The next field 712 is the particular event and gives insight to the CPU property being tracked. The event name is “probe/kernel/cpuUsage”, which, in this case, indicates that a usage property of the CPU is being tracked.

Field 714 indicates the frequency with which the probe will output event data on the system 100, and more particularly for the example given, will output data relevant to CPU usage on the system 100. Similarly, the last field 716 holds a value that dictates the frequency with which the probe will publish the data to one or more subscribing client devices 106.

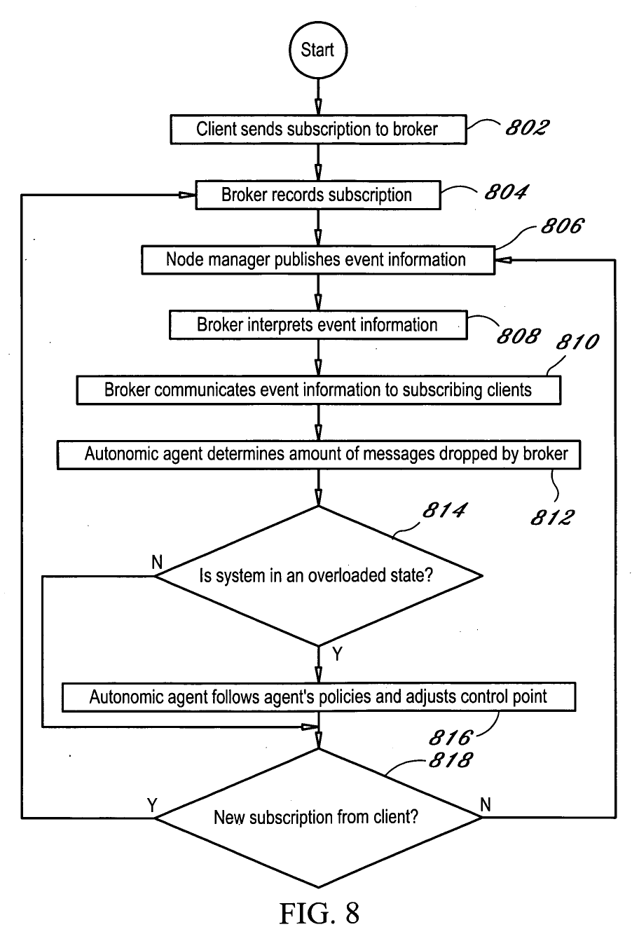

Referring now to FIG. 8, a flow diagram of the process of one embodiment of the present invention is shown. In the first step, 802, a client device 106 sends one or more subscription parameters to a broker device 102. The broker device 102 then, in step 804, records the parameters in a database or other storage method. The node manager 300 now begins forwarding messages to the broker device 102, in step 806. As previously mentioned, the node manager 300 sends messages to the broker 102 without regard to the type or content of the message and without regard to whether the messages are reaching their intended recipient.

The broker device 102 then interprets, in step 808, the messages arriving from the node manager 300 to determine routing attributes of each message. Based on the attributes, the broker 102 then routes the messages to the proper subscribing client devices 104, in step 810. The autonomic agent 400 calculates the number of messages dropped by the broker device 102 due to excess information sent by the node manager 300, in step 812. Based on the number of dropped messages, the autonomic agent 400 determines whether the system is in an overloaded state in step 814. If the system is found to be overloaded, the agent 400 follows its predefined policies and adjusts control points within the system to reduce the amount of information traffic sent from the node manager 300 to the broker device 102 in step 816. The broker 102 then checks for new subscriptions from clients devices 104, in step 818. If new subscriptions are detected, the flow moves back to step 804. If no new subscriptions have been submitted, the flow moves to step 806. Returning back to step 814, if it is found that the system is not in an overloaded state, the flow moves directly to step 818.

In yet another embodiment of the present invention, subscriber devices 106 expose their own, higher-level services to its own set of subscriber devices. For example, the subscriber device 106 can be accessed by a second level subscriber device for event information, such as event correlation and archiving/averaging. The second-level subscriber devices may consume events from the cluster monitoring system and higher-level services simultaneously.

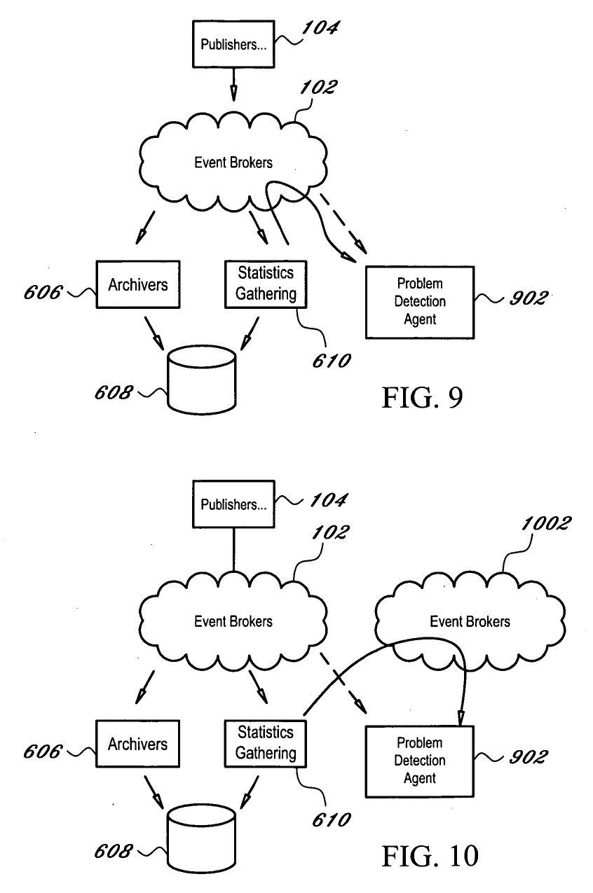

The basic system configuration previously shown in FIG. 6 is now shown in FIG. 9. In FIG. 9, publishers, or nodes 104, publish to a broker cloud 102 where a statistics gathering client device 610 and an archiver 606 subscribe to various events. In this embodiment of the present invention, the statistics gathering client 610 publishes its own events, such as average CPU load over a longer period of time than that measured by individual nodes 104, or average CPU load over a group of nodes 104. Additionally, a problem detection agent 902 may optionally receive events directly from the nodes (dotted line) such as high severity errors, and receive statistical events from the statistics gatherer 610, which are published through the same publish/subscribe infrastructure 100. An example of events from the statistics gathering service might include “average CPU load for the cluster,” while the problem detection agent would subscribe to receive events matching “average CPU load for the cluster, when it exceeds 95%.”

In yet another embodiment of the present invention, shown in FIG. 10, the statistics gathering client 610 collects information from the event brokers 102 and then publishes statistical information to a second group of one or more event broker devices, represented by a cloud 1002. The problem detection agent 902 subscribes to threshold events from a statistics gathering client 610 through one or more of the second set of broker devices 1002.

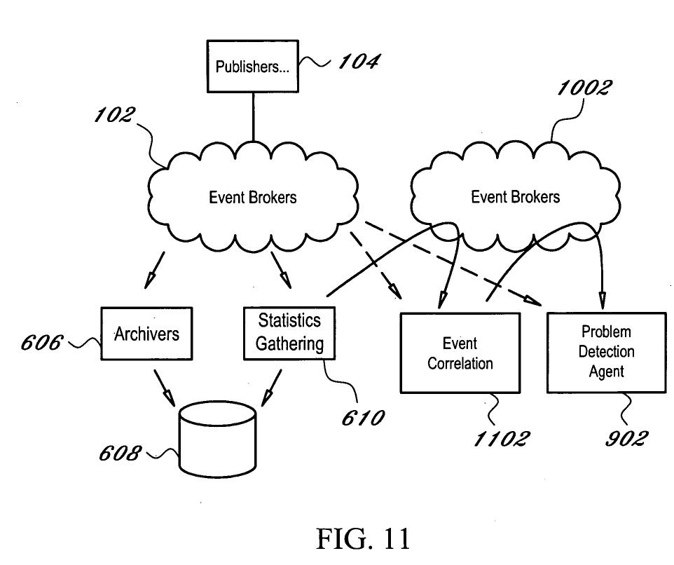

In a further step, shown in FIG. 11, the services can be further aggregated, building successively higher-level services deriving from the original cluster monitoring information. As shown in FIG. 11, a statistics-gathering client 610 can publish its own information to a second group of brokers (cloud) 1002. Another client, such as an event correlation device 1102, can receive event information from the statistics gathering device 610 through the second group of broker devices 1002 or other information directly from the first group of brokers 102.

The event correlation device 1102 can then publish information back to the second group of broker devices 1002, where other devices can subscribe to the event information. For instance, a problem detection agent 902 is able to receive event information directly from the first group of broker devices 102 or able to receive information published by the event correlation device 1102 through the second group of broker devices 1002.

As should now be clear, the subscription and publish services can be aggregated to any number of broker device groups and any number of subscribing/publishing devices, including device to device publication or device to infrastructure publication.

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A monitoring system comprising:
a data communication infrastructure having a plurality of nodes and a plurality of information flow control points;
one or more node managers each residing on a separate one of the plurality of nodes;
a broker communicatively coupled to at least one of the one or more node managers, the broker receiving from each node manager at least a portion of information flowing across the node on which the node manager resides;
at least one first-level client device communicatively coupled to the broker, the first-level client device for posting at least one parameter to the broker, receiving from the broker information matching the parameter, and publishing information back to the broker; and
at least one second-level client device communicatively coupled to the broker, the second-level client device for posting at least one parameter to the broker and receiving at least a portion of the information published to the broker by the first-level client.

2. The system according to claim 1, further comprising:
at least a third-level client device communicatively coupled to the broker and receiving from the broker information published by at least one of the first-level client devices and the second-level client devices.

3. The system according to claim 1, further comprising a problem detection client that subscribes to receive predefined information from the broker, the predefined information representing events occurring on the system.

4. The system according to claim 1, wherein the node manager further comprises:
at least one of an adapter that interprets events occurring on the node and transfers messages to the broker and a system probe that publishes information to the broker in accordance with a configurable schedule.

5. The system according to claim 4, wherein the probe is configurable to actively regulate a rate of information flow.

6. The system according to claim 4, wherein the adapter is configurable to actively regulate a type and quantity of messages published.

7. The system according to claim 1, wherein the information flow control points comprise at least one of an application setting, a logging system setting, an adapter message publish rate, a system probe information publish rate, a bandwidth switch, and a broker information transfer rate.

8. A monitoring system comprising:
a data communication infrastructure having a plurality of nodes and a plurality of information flow control points;
one or more node managers each residing on a separate one of the plurality of nodes;
a first broker communicatively coupled to the at least one of the one or more node managers, the first broker receiving from each node manager at least a portion of information flowing across the node on which the node manager resides;
a second broker;
at least one first-level client device communicatively coupled to the first broker and the second broker, the at least one first-level client device for posting at least one parameter to the first broker, receiving information from the first broker matching the at least one parameter, and publishing information to at least the second broker; and
at least one second-level client device communicatively coupled to the second broker, the second level client device for posting at least one parameter to the second broker and receiving at least a portion of information published to the second broker by the first-level client.

9. The monitoring system according to claim 8, wherein the at least one second level device is communicatively coupled to the first broker.

10. A method for monitoring a system and aggregating content-based information, the method comprising:
communicating, with a first client device, at least one event parameter to a broker;
communicating, with a node manager, system information from a node to a broker;
communicating, with the broker, portions of the system information matching the at least one event parameter to the first client device;
communicating, with the first client device, client-generated information to the broker; and
communicating, with the broker, at least a portion of the client-generated information to a second client device.

11. The method according to claim 10, further comprising:
communicating client-generated information from the second client device to a second broker; and
receiving with a third client device, at least a portion of the client-generated information from the second broker.

12. The method according to claim 10, wherein the node manager comprises at least one of an adapter that interprets an event occurring on the infrastructure and publishes messages to the broker and at least one system probe that publishes system information to the broker in accordance with a configurable schedule.

13. The method according to claim 10, further comprising:
limiting the system information communicated by adjusting one of an application setting, a logging system setting, an adapter message publish rate, a system probe information publish rate, a bandwidth switch, and a broker information transfer rate.

14. A computer program product for monitoring a system and routing information based on content, the computer program product comprising:
a storage medium readable by a processing circuit and storing instructions for execution by the processing circuit for performing a method comprising:
communicating, with a first client device, at least one event parameter to a broker;
communicating, with a node manager, system information from a node to a broker;
communicating, with the broker, portions of the system information matching the at least one event parameter to the first client device;
communicating, with the first client device, client-generated information to the broker; and
communicating, with the broker, at least a portion of the client-generated information to a second client device.

15. The method according to claim 14, further comprising:
communicating client-generated information from the second client device to a second broker; and
receiving, with a third client device, at least a portion of the client-generated information from the second broker.

16. The method according to claim 14, wherein the node manager comprises at least one of an adapter that interprets an event occurring on the infrastructure and publishes messages to the broker, and at least one system probe that publishes system information to the broker in accordance with a configurable schedule.

17. The method according to claim 14, further comprising:
limiting the system information communicated by adjusting one of an application setting, a logging system setting, an adapter message publish rate, a system probe information publish rate, a bandwidth switch, and a broker information transfer rate.
